(19) United States
(12) Patent Application Publication
(10) Pub. No.: US 2026/0281800 A1
(43) Pub. Date: Sep. 17, 2026

(54) DATA TRANSMISSION

(71) Applicant: Tencent Technology (Shenzhen) Company Limited, Shenzhen (CN)

(72) Inventors: Yixue LEI, Shenzhen (CN); Yuhang JIA, Shenzhen (CN)

(73) Assignee: Tencent Technology (Shenzhen) Company Limited, Shenzhen (CN)

(21) Appl. No.: 19/674,105

(22) Filed: May 11, 2026

Related U.S. Application Data
(63) Continuation of application No. PCT/CN2025/104236, filed on Jun. 27, 2025.

(30) Foreign Application Priority Data
Aug. 1, 2024 (CN) 202411057354.X

(51) Int. Cl. H04W 28/02; H04W 56/00

(52) U.S. Cl. CPC H04W 28/0268; H04W 56/001

(57) ABSTRACT

In a data transmission method, whether a plurality of quality of service (QoS) flows meets a synchronous transmission criterion is determined. In the method, when the plurality of QoS flows is determined to meet the synchronous transmission criterion, transmission resources are allocated to the plurality of QoS flows based on a synchronization requirement, whether transmission processes of the plurality of QoS flows meet the synchronization requirement is monitored, and the transmission resources allocated to the plurality of QoS flows are adjusted when the transmission processes of the plurality of QoS flows are determined not to meet the synchronization requirement. Apparatus and non-transitory computer-readable storage medium counterparts are also contemplated.

### RELATED APPLICATIONS

The present application is a continuation of International Application No. PCT/CN2025/104236, filed on Jun. 27, 2025, which claims priority to Chinese Patent Application No. 202411057354.X, filed on Aug. 1, 2024, and entitled “DATA TRANSMISSION METHOD AND APPARATUS, COMPUTER-READABLE MEDIUM, AND ELECTRONIC DEVICE.” The entire disclosures of the prior applications are hereby incorporated by reference.

### FIELD OF THE TECHNOLOGY

This disclosure relates to the field of computers and communications technologies, including data transmission methods and apparatuses, non-transitory computer-readable storage media, and electronic devices.

### BACKGROUND

In fifth generation (5G) mobile communications technologies and subsequent evolved systems (such as 5G-A and 6G), high-bandwidth interactive services are an important type of services, including cloud gaming, virtual reality (VR), augmented reality (AR), mixed reality (MR), extended reality (XR), cinematic reality (CR), and XR and media services (XRM).

These high-bandwidth interactive services have a very high requirement on the timeliness of transmission, and service streams of the services usually include a plurality of media types, such as audio, video, haptic, or other media types.

### SUMMARY

Embodiments of this disclosure provide data transmission methods and apparatuses, non-transitory computer-readable storage media, and electronic devices. According to one or more aspects of this disclosure, a plurality of QoS flows meeting synchronous transmission criterion (e.g., indicating that a certain level of transmission synchronization is required) may achieve a same transmission delay in a transmission process, thereby addressing the issue that played content may not be sufficiently synchronized due to different time delays caused by different QoS flows.

Other features and advantages of this disclosure will be described through or in view of the following detailed description of this disclosure.

An embodiment of this disclosure provides a data transmission method. In the method, whether a plurality of quality of service (QoS) flows meets a synchronous transmission criterion is determined. In the method, when the plurality of QoS flows is determined to meet the synchronous transmission criterion, transmission resources are allocated to the plurality of QoS flows based on a synchronization requirement, whether transmission processes of the plurality of QoS flows meet the synchronization requirement is monitored, and the transmission resources allocated to the plurality of QoS flows are adjusted when the transmission processes of the plurality of QoS flows are determined not to meet the synchronization requirement.

An embodiment of this disclosure provides a data transmission apparatus. The data transmission apparatus includes processing circuitry configured to determine whether a plurality of quality of service (QoS) flows meets a synchronous transmission criterion. The processing circuitry is configured to, when the plurality of QoS flows is determined to meet the synchronous transmission criterion, allocate transmission resources to the plurality of QoS flows based on a synchronization requirement, monitor whether transmission processes of the plurality of QoS flows meet the synchronization requirement, and adjust the transmission resources allocated to the plurality of QoS flows when the transmission processes of the plurality of QoS flows are determined not to meet the synchronization requirement.

An embodiment of this disclosure provides a non-transitory computer-readable storage medium. The non-transitory computer-readable storage medium stores instructions, which when executed by a processor, cause the processor to perform a data transmission method. In the method, whether a plurality of quality of service (QoS) flows meets a synchronous transmission criterion is determined. In the method, when the plurality of QoS flows is determined to meet the synchronous transmission criterion, transmission resources are allocated to the plurality of QoS flows based on a synchronization requirement, whether transmission processes of the plurality of QoS flows meet the synchronization requirement is monitored, and the transmission resources allocated to the plurality of QoS flows are adjusted when the transmission processes of the plurality of QoS flows are determined not to meet the synchronization requirement.

An embodiment of this disclosure provides a data transmission method, including: determining whether a plurality of quality of service (QoS) flows meet synchronous transmission criterion; and when it is determined that the plurality of QoS flows meet the synchronous transmission criterion, allocating transmission resources to the plurality of QoS flows according to the synchronous transmission criterion, to enable the plurality of QoS flows to meet a synchronization requirement when transmitted based on the allocated transmission resources.

An embodiment of this disclosure provides a data transmission apparatus, including: a determining unit, configured to determine whether a plurality of quality of service (QoS) flows meet synchronous transmission criterion; and a processing unit, configured to: when it is determined that the plurality of QoS flows meet the synchronous transmission criterion, allocate transmission resources to the plurality of QoS flows according to the synchronous transmission criterion, to enable the plurality of QoS flows to meet a synchronization requirement when transmitted based on the allocated transmission resources.

An embodiment of this disclosure provides a non-transitory computer-readable storage medium, having a computer program stored therein, and the computer program, when executed by processing circuitry (e.g., a processor), implementing a data transmission method in view of one or more aspects of this disclosure.

An embodiment of this disclosure provides an electronic device, including: processing circuitry (e.g., one or more processors); and a storage apparatus (e.g., including a non-transitory computer-readable storage medium), configured to store one or more computer programs, the one or more computer programs, when executed by the one or more processors, causing the electronic device to implement a data transmission method in view of one or more aspects of this disclosure.

An aspect of this disclosure provides a computer program product, including a computer program. The computer program is stored in a non-transitory computer-readable storage medium. Processing circuitry (e.g., a processor) of the electronic device reads the computer program from the non-transitory computer-readable storage medium and executes the computer program, to enable the electronic device to perform a data transmission method in view of one or more aspects of this disclosure.

The foregoing general descriptions and the following descriptions correspond to non-limiting examples and are not intended to limit this disclosure.

### BRIEF DESCRIPTION OF THE DRAWINGS

FIG. 1 is a schematic diagram of a system architecture according to an aspect of this disclosure.

FIG. 2 is a schematic diagram of a transmission process of a multimedia data packet according to some embodiments of this disclosure.

FIG. 3 is a schematic diagram of performing data transmission by using a plurality of QoS flows according to some embodiments of this disclosure.

FIG. 4 is a flowchart of a data transmission method according to some embodiments of this disclosure.

FIG. 5 is a flowchart of a data transmission method according to some embodiments of this disclosure.

FIG. 6 is a flowchart of a data transmission method according to some embodiments of this disclosure.

FIG. 7 is a block diagram of a data transmission apparatus according to some embodiments of this disclosure.

FIG. 8 is a schematic structural diagram of a computer system suitable for implementing an electronic device according to some embodiments of this disclosure.

### DETAILED DESCRIPTION

Descriptions of terms in this disclosure are provided as examples and are not intended to limit the scope of the disclosure.

Embodiments are described with reference to the accompanying drawings. However, one or more embodiments described in this disclosure may be implemented in various forms, and are not to be understood as being limited to these examples. Embodiments described in this disclosure are described to convey the concept of various aspects of this disclosure.

In addition, the features, structures, or characteristics described in this disclosure may be combined in one or more embodiments in any proper manner. In the following description, many specific details are provided to facilitate full understanding of one or more embodiments of this disclosure. However, when implementing one or more technical solutions of this disclosure, not all features described in this disclosure are used. In some examples, one or more aspects of this disclosure may be omitted, modified, reordered, or combined in various manners.

In one or more embodiments of this disclosure, the term “module” or “unit” refers to a computer program with a predetermined function or a part of the computer program and works, together with other related parts, to implement a preset target, and may be completely or partially implemented by using software, hardware (for example, processing circuitry or a memory) or a combination thereof. A module or unit implemented by software may include instructions stored in a non-transitory computer-readable storage medium that, when executed by processing circuitry, cause the processing circuitry to perform the functions of the module or unit. Similarly, one processor (or a plurality of processors or memories) may be configured to realize one or more modules or units. In addition, each module or unit may be a part of an overall module or unit including the module or unit function.

The block diagrams shown in the accompanying drawings are functional entities and do not necessarily correspond to physically independent entities. In some aspects, the functional entities may be implemented in a software form, or in one or more hardware modules or integrated circuits, or in at least one of different networks, or processor apparatuses, or microcontroller apparatuses.

The flowcharts shown in the accompanying drawings are descriptions of non-limiting examples, some content and operations/blocks may be omitted, and some operations/blocks may be performed in a different order. For example, some operations/blocks may further be broken down, but some operations/blocks may be merged or partially merged. Therefore, an actual execution order may change according to an actual situation. “A plurality of” mentioned herein means two or more. “And/or” describes an association relationship for describing associated objects and represents that three relationships may exist. For example, A and/or B may represent the following three cases: Only A exists, both A and B exist, and only B exists. The character “/” generally denotes an “or” relationship between the associated objects.

As used in this disclosure, the phrase “at least one of A, B, or C” is intended to mean any one of A, B, or C, or any combination thereof. Similarly, “one of A or B” includes A, B, or both.

With the development of 5G and subsequent evolved systems (such as 5G-A and 6G), many multimedia services that require a large data volume and a short delay are applied, for example, an interaction service such as a cloud game service, VR, AR, MR, XR, or CR.

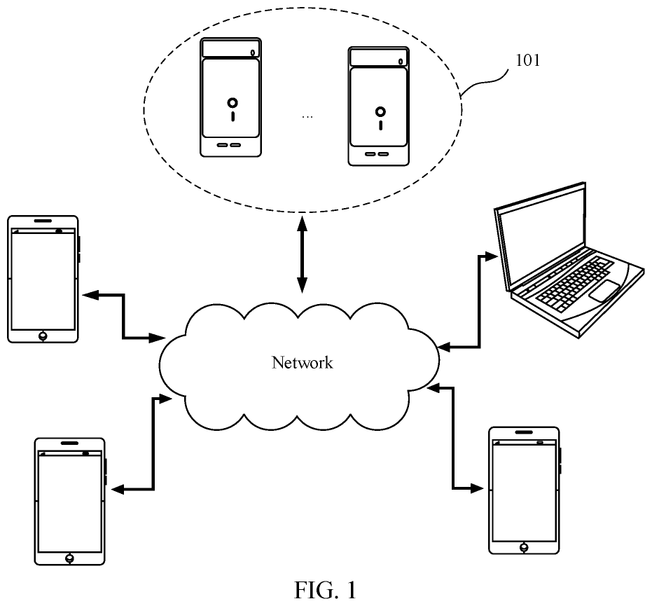

For example, in a cloud game scenario shown in FIG. 1, a cloud server 101 is configured to run a cloud game. The cloud server 101 may render a game picture, encode an audio signal and a rendered image, and finally transmit coded data obtained through encoding to game clients via a network. The game clients may be user equipment (UE), such as a smartphone, a tablet, a laptop, a desktop computer, an intelligent TV set, a smart household device, an in-vehicle terminal, or an aircraft, having a basic streaming media playback capability, a human-computer interaction capability, a communications capability, and the like. Alternatively, the game clients may be an application program running in a terminal device. In an example, the game clients may decode encoded data transmitted by the cloud server 101, to obtain an analog audio and video signal, and play the analog audio and video signal.

FIG. 1 merely illustratively represents a system architecture of a cloud game system, and does not limit a specific architecture of the cloud game system. For example, in other embodiments, the cloud game system may further include a back-end server for scheduling, and the like. The cloud server 101 may be an independent physical server, or a server cluster or a distributed system including a plurality of physical servers, or may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The game client and the cloud server 101 may be directly or indirectly connected to each other in a wired or wireless communication protocol. This is not limited in this disclosure herein.

In the foregoing various multimedia-based interactive service application scenarios, due to the fact that a multimedia data packet is huge, during transmission, the multimedia data packet may be split into a plurality of data packets for transmission. In an example, as shown in FIG. 2, in a 5G system, a user plane may include an application server, a user plane function (UPF), a next generation nodeB (gNB), and UE. For some typical service scenarios, a multimedia data packet is transmitted in a downlink direction, for example, from an application server (AS) to the UPF, and then is transmitted to the UE by using the gNB. During transmission, a multimedia data packet (for example, an XR data packet in FIG. 2) is split at an application layer of an application server. After the split data packets arrive at the UPF from the application server as IP data packets, the 5G system transmits sub-data packets to a UE end by using a protocol data unit (PDU) session. The sub-data packets are delivered upwards from a protocol stack level by level at the UE end, to perform recombination to restore the multimedia data packet.

In the system shown in FIG. 2, an L1 layer refers to a physical layer and is configured to enable original data to be transmitted on various physical media; an L2 layer refers to a data link layer, and the data link layer provides a service for a network layer based on a service provided by the physical layer; and the Internet protocol (IP) layer (e.g., a network layer) is configured to implement data transport between two end systems.

As described above, for a multimedia service (such as an XRM service), a multimedia data packet may be divided into a plurality of data packets for transmission. A data packet formed by a single multimedia service frame or a group of packets (GoP) may have a large byte quantity and may be carried by a series of IP data packets. There is a correlation between the IP data packets, and processing these packets according to the correlation may effectively save a wireless network bandwidth. For example, a plurality of IP data packets may be transmitted during transmission, and the plurality of IP data packets may form a PDU set.

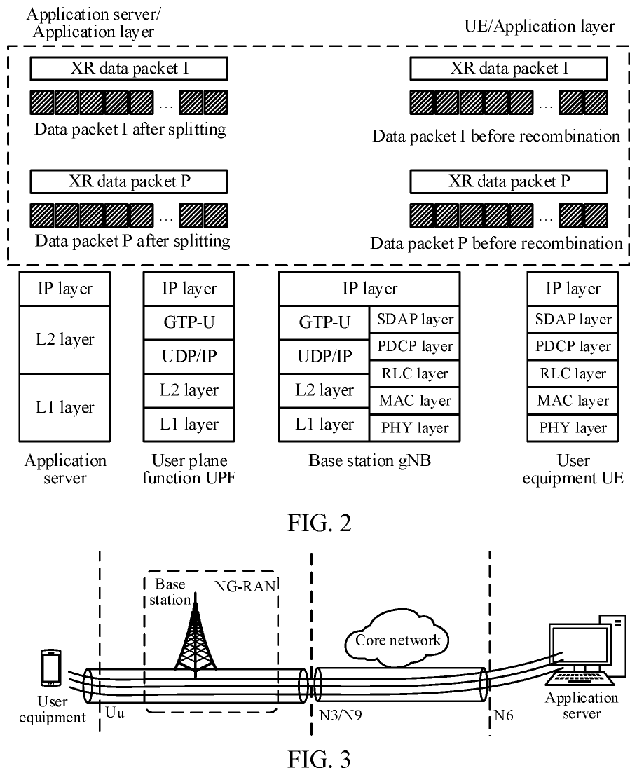

In addition, in a service of a multimedia service (such as an XRM service), a single service stream usually includes a plurality of media types, such as audio, video, and haptic, or other media types. As shown in FIG. 3, during transmission, service streams of different media types may be mapped to different quality of service (QoS) flows. The different QoS flows may have different time delays during transmission, for example, a time delay between a radio access network (RAN) and a UPF. Further, when a plurality of QoS flows arrive at a receive end through different transmission paths, a situation in which service data of different media types is not synchronized when the receive end generates, according to the plurality of received QoS flows, media content for playing may be caused.

Based on the foregoing, one or more embodiments of this disclosure provide a new data transmission solution. When a plurality of QoS flows is determined to meet a synchronous transmission criterion (e.g., indicating that a certain level of transmission synchronization among the plurality of QoS flows is required), transmission resources are allocated to the plurality of QoS flows based on a synchronization requirement, so that the plurality of QoS flows meet the synchronization requirement (for example, a same transmission delay) when transmitted based on the allocated transmission resources. In this way, a same transmission delay may be achieved in transmission processes of the plurality of QoS flows meeting the synchronous transmission criterion, thereby avoiding a situation in which played content is not synchronized due to different time delays of different QoS flows and improving the user experience of a multimedia service.

The following describes further implementation details of one or more embodiments of this disclosure.

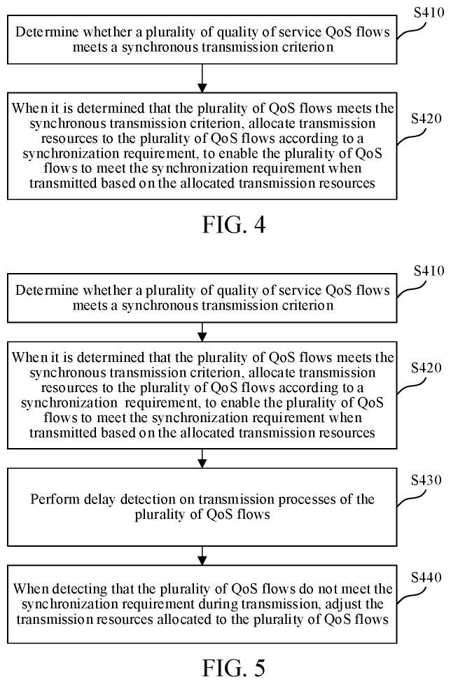

FIG. 4 is a flowchart of a data transmission method according to some embodiments of this disclosure. The data transmission method may be performed by an access network element, for example, may be performed by a base station device. In some aspects, the non-limiting example shown in FIG. 4 may be performed by another electronic device having a computing processing function. Referring to FIG. 4, the data transmission method includes at least S410 to S420, which are described in further detail as follows:

S410: Determine whether a plurality of quality of service (QoS) flows meets synchronous transmission criterion.

In some embodiments, different media components of a multimedia service (for example, a cloud game/XR service) may be transmitted by using differential QoS flows. A media type of a multimedia service may include an audio (delay sensitive), video (bandwidth sensitive), haptic (jitter sensitive), other media types, or the like. Service data packets of different media types may have different QoS requirements, or may have a same QoS requirement. If the service data packets of different media types have different QoS requirements, the service data packets of the different media types may be mapped to different QoS flows.

The multimedia service may be, for example, a cloud game service, a VR service, an AR service, an MR service, an XR service, an XRM service, or a CR service. A data packet of a multimedia service may be transmitted in a form of a service data packet set (that is, a PDU set), due to the fact that a data packet formed by a single multimedia service frame or GoP may have a large quantity of bytes and may be divided into a series of data packets for carrying, and these data packets have a particular correlation. Therefore, these data packets having the correlation may be referred to as the PDU set. In other embodiments of this disclosure, a service data stream may be transmitted in a per-packet manner.

For example, for a cloud game service, the cloud game service may include a service data packet of an audio type, a service data packet of a video type, or a service data packet of a haptic or another type. Due to the fact that service stream data packets of a plurality of media types are associated with a same multimedia service, if the service stream data packets are mapped to different QoS flows during transmission, these QoS flows are associated. For example, the QoS flows may meet a synchronous transmission criterion, that is, delays between the QoS flows are to be consistent or within a delay range.

In some embodiments, a designated indication parameter from a core network element may be received, and then whether the plurality of QoS flows meets a synchronous transmission criterion is determined according to the designated indication parameter. That is, in this embodiment, that the plurality of QoS flows meets a synchronous transmission criterion is determined in an explicit indication parameter mode (e.g., based on a designated indication parameter). In some embodiments, the designated indication parameter may include a multi-modality service identifier (MMSID), and the multi-modality service identifier is configured to indicate that a plurality of QoS flows in a same PDU session have an association relationship.

In some embodiments, whether a plurality of QoS flows meets a synchronous transmission criterion may be inferred according to one or more other parameters (e.g., an implicit indication parameter) that are not designated to indicate whether the plurality of QoS flows meets the synchronous transmission criterion. For example, QoS parameters of a session level (PDU session level) and a QoS flow level (QoS flow level) may be analyzed from user equipment-related context information (UE context), to infer whether a plurality of QoS flows meets a synchronous transmission criterion.

In an example, QoS configurations are usually associated with specific session entities (such as EPS Bearers or 5GS QoS flows). These entities are used as logic carriers for implementing a QoS policy and carrying functions of a differential service. For example, in a 4G system, an EPS bearer is a basic unit of a QoS configuration. Data streams on a same bearer may have a same QoS configuration. In a 5G system, a QoS flow is used as a basic unit of a QoS configuration. The QoS parameter may include:
a priority parameter, configured to determine a processing sequence of a data packet in a scheduling queue;
a rate control parameter, such as a maximum bit rate (MBR) or a guaranteed bit rate (GBR), configured to control a data transmission speed;
a packet filter set, configured to associate a data packet in a network with a specific QoS rule; and
a QoS rule identifier (such as 5QI or ARP), configured to uniquely identify a QoS rule.

When determining whether QoS flows meet a synchronous transmission criterion according to a session-level parameter included in the UE context, the following operations may be performed: first, looking up the UE Context for a QoS parameter associated with a specific session, and then determining, by analyzing an association of these parameters, whether the plurality of QoS flows meets the synchronous transmission criterion.

In some embodiments, when performing synchronization identification according to one or more other parameters, determining of a synchronization relationship between the plurality of QoS flows may be determined by parsing a QoS parameter of a QoS flow level.

In an example, the QoS flow, as the finest QoS differentiation unit in a PDU session, relies on a set of standardized QoS parameters for configuration and management. These parameters not only define a service characteristic of a single QoS flow, but also implicitly disclose a potential association between different QoS flows. The QoS parameter of the QoS flow level may include: a QoS flow identifier (QFI), a QoS class identifier (5QI), an allocation and retention priority (ARP), a guaranteed flow bit rate (GSBR), a maximum flow bit rate (MFBR), and the like.

The QFI is configured to identify a QoS flow. The 5QI is configured to index a 5G QoS characteristic, different 5QI values represent different QoS classes, the ARP parameter defines a priority, a preemption capability, and preemptability of a QoS flow, and a GBR QoS flow. The GBR and the MFBR respectively represent a guaranteed bit rate and a maximum bit rate.

The association between the parameters is reflected in that: QoS flows having a same 5QI value may have a similarity in QoS processing; QoS flows having a same ARP parameter follow a same processing policy during resource allocation; and QoS flows having similar GFBR and MFBR values may have similar rate guaranteed requirements. The parameter correlation provides a technical basis for synchronization identification. Therefore, whether a plurality of QoS flows meets a synchronous transmission criterion may be identified based on the QoS parameter of the QoS flow level. When the plurality of QoS flows presents a same or similar key parameter, the plurality of QoS flows may be determined to have a service synchronization requirement. For example, whether different QoS flows have a same ARP parameter or a same delay parameter is identified according to the QFI. If the different QoS flows have a same or similar delay parameter, there is a synchronous transmission criterion between the QoS flows.

In some embodiments, in addition to the foregoing QoS parameters, for service data transmitted in a form of a PDU set, a corresponding QoS parameter may further include at least one of the following parameters: a PDU set delay budget (PSDB), a PDU set error rate (PSER), a maximum data burst volume (MDBV), or a packet delay variation/jitter (PDV). For service data transmitted in a form of a single data packet (per-packet), a corresponding QoS parameter may further include at least one of the following parameters: a data packet delay budget (PDB), a data packet error rate (PER), or a maximum data burst.

In some embodiments, when a core network element indicates a synchronization requirement, a plurality of QoS flows included in a same PDU session may be directly identified as a synchronous associated flow. In this implicit identification mechanism, a parameter comparison process is omitted, and a plurality of QoS flows included in a same PDU session are directly identified as QoS flows meeting synchronous transmission criterion without indication using another parameter.

Still referring to FIG. 4, S420: When it is determined that the plurality of QoS flows meets the synchronous transmission criterion, allocate transmission resources to the plurality of QoS flows based on a synchronization requirement, to enable the plurality of QoS flows to meet the synchronization requirement when transmitted based on the allocated transmission resources.

In some embodiments, if the plurality of QoS flows is determined to meet the synchronous transmission criterion, a synchronous transmission parameter for the plurality of QoS flows may be generated. For a data stream using a PDU set transmission mode, the synchronous transmission parameter includes: a PDU set delay budget; for a data stream based on single-packet transmission, the synchronous transmission parameter includes: a data packet delay budget.

By converting the synchronous transmission requirement into a synchronous transmission parameter, an abstract performance indicator may be converted into a specific and configurable parameter (such as an AN-PDB or a PSDB), to implement flexible control and optimization of a system. By converting the synchronous transmission requirement into a standardized delay parameter (for example, an AN-PDB, for use in a non-PDU set scenario), a system may define a transmission delay threshold, to facilitate real-time detection and dynamic adjustment of resource allocation, thereby avoiding deterioration of synchronization caused by transmission jitter from a radio access network (for example, an NG-RAN to a UE section). In one or more embodiments of this disclosure, not only maintenance of a synchronization policy is simplified (for example, core logic may not be reconstructed when a threshold is modified), but also serial expansion is supported, thereby adapting to QoS requirements of different service scenarios.

In some embodiments, when transmission resources are allocated to a plurality of QoS flows according to a synchronous transmission requirement, when synchronous transmission requirements of QoS flows may be met by using a single data radio bearer (DRB), the plurality of QoS flows may be transmitted by using the single data radio bearer, and precise time alignment is implemented by sharing a radio resource. If the synchronous transmission requirements of the QoS flows may not be met by using the same DRB, independent data radio bearers may be allocated to the QoS flows, to enable the plurality of QoS flows to meet the synchronous transmission requirement when the plurality of QoS flows perform transmission based on different data radio bearers.

FIG. 5 is a flowchart of a data transmission method according to some embodiments of this disclosure. The data transmission method may be performed by an access network element, for example, may be performed by a base station device. In some aspects, one or more embodiments shown in FIG. 5 may alternatively be performed by another electronic device having a computing processing function. Referring to FIG. 5, based on S410 to S420 shown in FIG. 4, the data transmission method further includes S430 and S440, which are described in further detail as follows:

S430: After allocating the transmission resources to the plurality of QoS flows according to the synchronous transmission requirement, perform delay detection on transmission processes of the plurality of QoS flows. In some examples, when the plurality of QoS flows is determined to meet the synchronous transmission criterion, transmission resources are allocated to the plurality of QoS flows based on a synchronization requirement in S420. In some examples, in S430, whether transmission processes of the plurality of QoS flows meet the synchronization requirement is monitored.

A data packet is usually classified into a transparent mode (TM), an acknowledged mode (AM), and an unacknowledged mode (UM) during transmission. In a transparent mode TM, a device or a system for transmitting data is “transparent” to transmitted data, that is, content of the data is not modified or processed. When data is transmitted in an unacknowledged mode UM, a receiving party does not need to wait for confirmation, and a transmitting party does not wait for any feedback from the receiving party after transmitting the data. Therefore, the data transmission efficiency is relatively high, and is suitable for a scenario in which a requirement on real-time quality is relatively high but a requirement on data transmission accuracy is relatively low. The acknowledged mode AM is a more reliable transmission mode. In the AM mode, a transmitting party may wait for an acknowledged message from a receiving party after transmitting data, to improve the accuracy of the received data. If a receiving party does not receive data or received data is incorrect, the receiving party transmits a non-acknowledged (NACK) message to a transmitting party, to request the transmitting party to retransmit the data. This mechanism may improve completeness and accuracy of the data, but correspondingly, some transmission delays are added.

In some embodiments, for different transmission modes, a differential delay detection solution is provided. For a QoS flow in an unacknowledged mode (UM), in an uplink direction, delay measurement is performed through an RLC instance of a receive end on uplink transmission; and in a downlink direction, delay measurement is performed through an RLC instance of a transmit end on downlink transmission.

In some embodiments, for a QoS flow using an acknowledged mode (AM), due to the fact that receiving and transmitting shares one RLC instance, the RLC instance may perform bidirectional delay measurements in uplink and downlink directions. For example, the delay detection may be performed through an RLC instance shared by the uplink transmission and the downlink transmission.

In some embodiments, for a synchronous transmission requirement of different service types, different measurement modes may be configured: measurement performed by using a data packet as a unit, suitable for a delay and jitter sensitive service; measurement performed by using a transport block (TB) as a unit, suitable for a large flow service. Measurement overheads may be reduced through batch processing.

In some embodiments, if a transmission delay difference between data packets of a plurality of QoS flows is within a reference range (e.g., a set threshold), the plurality of QoS flows may be determined to meet a synchronization requirement during transmission; or when a transmission delay difference between data packets of a plurality of QoS flows is not within a set threshold, the plurality of QoS flows may be determined not to meet a synchronization requirement during transmission. According to one or more aspects, when a transmission delay difference of a plurality of QoS flows is within a particular range, the plurality of QoS flows are considered to be synchronous, thereby avoiding mis-determining caused by delay jitter.

In some embodiments, when delay detection is performed on transmission processes of the plurality of QoS flows, a synchronization state of the QoS flows may be characterized through multi-state conversion of a state machine. For example, whether the plurality of QoS flows meet the synchronization requirement during transmission is indicated according to a delay detection result of the plurality of QoS flows by using different states of a state machine, where the state machine includes a synchronized state and an unsynchronized state. In some aspects, the state machine may further include other states, for example, a pending unsynchronized state, a slightly unsynchronized state, or a severely unsynchronized state.

S440: When detecting that the plurality of QoS flows do not meet the synchronization requirement during transmission, adjust the transmission resources allocated to the plurality of QoS flows. For example, the transmission resources allocated to the plurality of QoS flows are adjusted when the transmission processes of the plurality of QoS flows are determined as not meeting the synchronization requirement.

In some embodiments, local resource adjustment is first performed, to allocate more transmission resources for a high-delay QoS flow or switch to a relatively idle transmission link, so as to reduce a delay of the QoS flow. In some embodiments, if the plurality of QoS flows still do not meet the synchronization requirement when a set duration has elapsed, coordinated optimization of a core network may be started, to transmit a notification message to a core network element, so that the core network element adjusts transmission parameters for the plurality of QoS flows. For example, the core network element may adjust the QoS parameters for the plurality of QoS flows by using a PDU session modification procedure.

The following describes further implementation details of one or more embodiments of this disclosure with reference to FIG. 6 by using an example in which the 5G system processes an XRM service.

In some aspects, one or more embodiments of this disclosure may correspond to an end-to-end XRM service stream, a synchronization relationship between QoS flows is identified at a next generation radio access network (NG-RAN) base station, and an appropriate radio resource is selected for different QoS flows, so that a same transmission delay may be achieved between the QoS flows having a synchronization relationship in a transmission process in the NG-RAN. In an example, referring to FIG. 6, the following steps may be included:

S601: After a PDU session and a QoS flow are established/modified, an NG-RAN determines whether a plurality of QoS flows meets a synchronous transmission criterion, and converts a corresponding synchronization requirement into a parameter when the plurality of QoS flows is determined to meet a same synchronization generation requirement.

In some embodiments, the synchronous transmission criterion of the plurality of QoS flows may be explicitly indicated based on a parameter provided by the core network.

In an example, an MMSID defined by the 3rd generation partnership project (3GPP) SA2 R18 is configured to identify a parameter of an association relationship between a plurality of media streams in an extended reality media (XRM) service. By using the parameter, multimedia streams (such as audio, video, and haptic feedback) pertaining to a same service scenario may be performed by using a unified service identifier, and may indicate a requirement on synchronization between different flows, for example, a requirement on strict time sequence alignment between video streams and motion sensor data in a VR scenario. A network side may use flows marked as a same MMSID as an integral part for resource allocation. However, the parameter has a particular restraint and is introduced to indicate dependency between different flows, and when allocating and scheduling transmission resources, a network may not accept or reject a part thereof, and may use the parameter as a whole. Therefore, that the parameter may be configured to indicate the transmission synchronization requirement based on one or more of the following two assumptions: different QoS flows having a synchronization dependency may pertain to a same PDU session, and flows within a same XRM service use a unified synchronization grade.

In some embodiments, the synchronization requirement of the plurality of QoS flows may be implicitly inferred. In this method, a new indication parameter may not be introduced to the AF and the core network, and the synchronization between different QoS flows is analyzed by analyzing a control plane or user plane entity. For example, implicit inferring may include but is not limited to: parsing a QoS parameter (for example, delay sensitivity in the QoS parameter) and a reliability indicator) or extracting information from a UE context (for example, QoS parameters of a PDU session level and a QoS flow level in a UE context). Such the solution of inferring a QoS flow synchronous transmission requirement by using one or more other parameters may avoid explicit signaling overhead, and synchronization requirement inference is implemented by using an existing QoS parameter system, to keep compatibility with an existing 5G QoS framework without modifying a core network architecture.

In an example, the NG-RAN may analyze QoS parameters of the session level and the QoS flow level from the UE context stored by the gNB, to analyze whether the different QoS flows meet synchronous transmission criterion (e.g., indicating that a certain level of transmission synchronization among the plurality of QoS flows is required). In some aspects, the NG-RAN may automatically determine that a plurality of flows in a PDU session of UE meet synchronous transmission criterion when the core network declares the synchronous transmission may be required but does not specify which QoS flows are to be synchronously transmitted.

In some embodiments, the synchronous transmission requirement may be converted into a PDB parameter, such as an AN-PDB (corresponding to a non-PDU set) parameter or a PSDB parameter (corresponding to a PDU set). The AN-PDB is configured for an independent data stream of a non-PDU set, and defines a maximum delay threshold allowed for a data packet from a transmit end to a receive end of an application layer. Corresponding the synchronous transmission requirement to an AN-PDB parameter is performed based on that: assuming that the data packet meets the synchronization requirement when arriving at the NG-RAN, the synchronization is not further deteriorated due to transmission between the NG-RAN and the UE. The PSDB parameter is configured for a PDU set (such as an XR multi-modality service stream group), to set a coordinated transmission delay budget of an entire group of data packets. By uniform resource scheduling, a time difference of data packets of flows in a group at a receive end may be configured to meet a threshold.

S602: The NG-RAN performs data transmission by using one or more DRBs, and detects transmission delays of the QoS flows.

In some embodiments, when any one of the following conditions is met, the plurality of QoS flows may be transmitted by using a single DRB to improve the synchronization:
the plurality of QoS flows having a same 5QI;
sharing a same delay budget parameter (PDB indicator, or PDU indicator);
having a matched PER indicator or MDBV indicator; and
an NG-RAN evaluation confirmation bill DRB meeting the QoS requirement of the QoS flows.

A same DRB provides consistent underlying transmission characteristics (such as a scheduling priority and an HQ mechanism) for carried QoS flows, so as to naturally maintain the consistency of inter-flow delays.

In some embodiments, when different QoS flows have the following characteristic differences, the NG-RAN may perform transmission by using independent DRBs: a service type difference: including different XRM media streams/types (for example, video/haptic feedback separation), pertaining to different PDU sets and importance information (PSI) of the PDU sets being inconsistent;

QoS parameter conflict: delay requirements are the same but reliability indicators (PER) are not matched, that is, reliability indicators between different QoS flows are different; other key parameters (such as a jitter tolerance) may not be met by using a single DRB.

Different DRBs are used to transmit the plurality of QoS flows, thereby implementing a differential scheduling policy, and avoiding a reliability requirement conflict.

In some embodiments, a base station is configured to perform delay detection on a plurality of QoS flows that meets a synchronous transmission criterion, and such information may be used to enable different QoS flows to meet a same delay indicator.

In some embodiments, in an RLC UM mode, if up link (UL) transmission is performed, delay measurement may be performed by an RLC instance of a receive end (RX). If downlink (DL) transmission is performed, delay measurement may be performed by an RLC instance of a transmit end (TX).

In some embodiments, in an RLC AM mode, if UL and DL share an RLC instance, whether a service stream of the plurality of QoS flows meets a synchronization requirement may be analyzed by analyzing a sequence number delay change trend of the RLC instance.

S603: If the synchronization requirement is not met, trigger a reporting mechanism and a QoS parameter modification.

In some embodiments, if transmission between a plurality of QoS flows detected by the NG-RAN meets a synchronization requirement, the NG-RAN may continuously perform transmission. If the synchronization requirement is not met, the NG-RAN may adjust a resource transmission algorithm to enable the plurality of QoS flows to meet the synchronization requirement. If the synchronization requirement is still not met within a set duration, the NG-RAN may transmit a notification message to a 5G core network (5GC), so that the 5GC triggers update of a parameter of the QoS flows after receiving the notification.

In some embodiments, after receiving the notification, the 5GC may alternatively transmit the notification to the AF, so that the AF may perform adaptive adjustment. For example, the AF regenerates QoS requirement information for the plurality of QoS flows, and transmits the QoS requirement information to the core network element, to adjust a processing policy for the plurality of QoS flows.

In some embodiments, the following manners may be used for detecting transmission delays of a plurality of QoS flows and determining whether a synchronization requirement is met:
packet-level detection: performing delay measurement on each data packet and performing synchronous determining; and
MAC TB-level detection: performing delay detection and synchronization determining each time when a MAC TB is transmitted.

In the foregoing determining manner, mis-determining may be caused in a scenario of fast fading (for example, moving at a high speed) of a radio channel, and therefore the determining manner may not be suitable for a case in which the radio channel changes sharply. Therefore, to improve the expandability of a system, determining of a synchronization requirement may be designed as a state machine or threshold determining, and is implemented in a user plane RLC or a MAC instance.

In an example, when the threshold determining is performed, a threshold may be set. When a delay change of data packet transmission is within a threshold range, the synchronization requirement is met, and a reporting process is not triggered. If the delay variation of the data packet transmission exceeds the threshold range, the synchronization requirement is not met, and a reporting process may be triggered.

When determining is performed by using a state machine, a state machine may be designed to include two states: synchronous and unsynchronized, or may include other states, and a conversion condition between the states may be set to dynamically follow a change of the states.

In some embodiments, the manner of determining by using a state machine and the manner of determining by using a threshold may be jointly implemented, or may be separately implemented.

In some aspects, one or more embodiments of this disclosure provide a new data transmission solution, so that the NG-RAN base station may identify a synchronization relationship between QoS flows, and select an appropriate radio resource for different QoS flows, such that a same transmission delay may be achieved between the QoS flows having a synchronization relationship in a transmission process in the NG-RAN. In some aspects, embodiments of this disclosure may address the issue that the user experience of a multimedia service at a receive end is affected by different delays caused by that a plurality of QoS flows are transmitted in a 5G/6G network after the multimedia stream is mapped to the plurality of QoS flows.

In some aspects, one or more embodiments of this disclosure are not only suitable for a 5G system, but also suitable for a future evolved mobile communication system. In some aspects, one or more embodiments of this disclosure are not only suitable for an XRM service, but also suitable for processing of another multimedia service stream.

The following introduces an apparatus embodiment of this disclosure, which may be configured to perform the data transmission method in the foregoing embodiments of this disclosure. For details not disclosed in the apparatus embodiment of this disclosure, reference is made to one or more embodiments of the data transmission method in this disclosure.

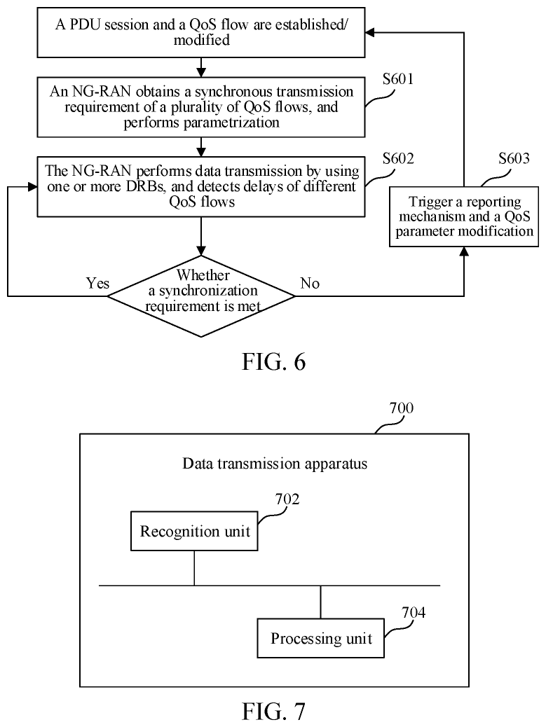

FIG. 7 is a block diagram of a data transmission apparatus according to some embodiments of this disclosure. The data transmission apparatus may be applied to an access network element, for example, may be applied to a base station device. In some aspects, the data transmission apparatus shown in FIG. 7 may alternatively be applied to another electronic device having a computing processing function.

Referring to FIG. 7, a data transmission apparatus 700 according to some embodiments of this disclosure includes: a determining unit 702 and a processing unit 704.

The determining unit 702 is configured to determine whether a plurality of quality of service (QoS) flows meets a synchronous transmission criterion (e.g., indicating that a certain level of transmission synchronization among the plurality of QoS flows is required); and a processing unit 704, configured to: when the plurality of QoS flows is determined to meet the synchronous transmission criterion, allocate transmission resources to the plurality of QoS flows based on a synchronization requirement, to enable the plurality of QoS flows to meet the synchronization requirement when transmitted based on the allocated transmission resources.

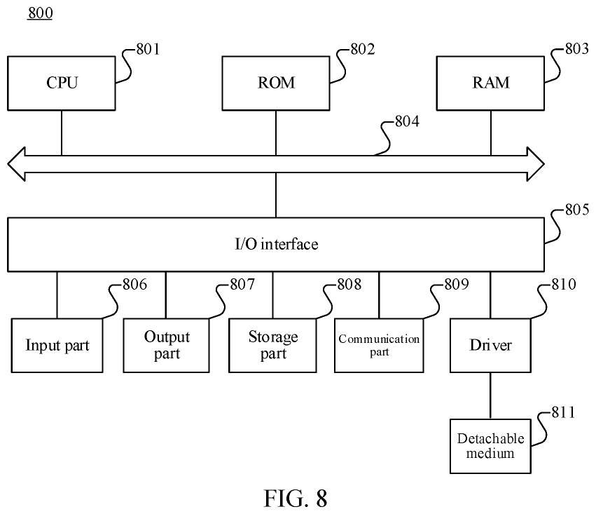

FIG. 8 is a schematic structural diagram of a computer system suitable for implementing an electronic device according to one or more embodiments of this disclosure. The electronic device may be an access network element in the foregoing embodiments, for example, a base station device.

A computer system 800 of the electronic device shown in FIG. 8 is merely an example, and does not constitute any limitation on the function and scope of use of one or more embodiments of this disclosure.

As shown in FIG. 8, the computer system 800 includes processing circuitry (e.g., a central processing unit (CPU) 801), which may perform various suitable actions and processes, for example, performing the method in the foregoing embodiments, based on a program stored in a read-only memory (ROM) 802 or a program loaded from a storage part 808 into a random access memory (RAM) 803. The RAM 803 further has various programs and data for system operation stored therein. The CPU 801, the ROM 802, and the RAM 803 are connected to each other through a bus 804. An input/output (I/O) interface 805 is also connected to the bus 804.

The following components may be connected to the I/O interface 805: an input part 806 including a keyboard, a mouse, and the like; an output part 807, including a cathode ray tube (CRT), a liquid crystal display (LCD), and a speaker; a storage part 808 including a hard disk and the like; and a communications part 809 including a network interface card such as a local area network (LAN) card or a modem. The communication part 809 performs communication processing by using a network such as the Internet. A drive 810 is also connected to the I/O interface 805. A removable medium 811, such as a magnetic disk, an optical disk, a magneto-optical disk, or a semiconductor memory, is installed on the drive 810, so that a computer program read from the removable medium is installed into the storage part 808.

According to one or more embodiments of this disclosure, the process described in the foregoing reference flowchart may be implemented as a computer software program. For example, an embodiment of this disclosure includes a computer program product, including a computer program carried on a non-transitory computer-readable storage medium (e.g., ROM 802 or storage part 808), the computer program being configured to perform the methods shown in the flowcharts. In such an embodiment, the computer program may be downloaded and installed from a network through the communication part 809, or installed from the removable medium 811. When the computer program is executed by the central processing unit (CPU) 801, various functions defined in the system of one or more embodiments of this disclosure are performed.

The non-transitory computer-readable storage medium described in one or more embodiments of this disclosure may be, for example (but not limited to), an electric, magnetic, optical, electromagnetic, infrared, or semi-conductive system, apparatus, or device, or any combination of the above. A more specific example of the non-transitory computer-readable storage medium may include, but is not limited to: an electrical connection having one or more wires, a portable computer disk, a hard disk, a read-only memory (RAM), a read-only memory (ROM), an erasable programmable read only memory (EPROM), a flash memory, an optical fiber, a portable compact disc read-only memory (CD-ROM), an optical storage device, a magnetic storage device, or any appropriate combination of the above. In this disclosure, the non-transitory computer-readable storage medium may be any tangible medium including or storing a computer program. The computer program may be used by or in combination with an instruction execution system, apparatus, or device. The non-transitory computer-readable medium may transmit, propagate, or transmit a program used by or in combination with the instruction execution system, apparatus, or device. The computer program included in the non-transitory computer-readable medium may be transmitted by using any suitable medium, including but not limited to: wireless, wired, and the like, or any suitable combination thereof.

The flowcharts and block diagrams in the accompanying drawings illustrate possible system architectures, functions and operations that may be implemented by a system, a method, and a computer program product according to various embodiments of this disclosure. Each block in the flowchart or the block diagram may represent a module, a program segment, or a part of code. The module, the program segment, or the part of the code includes one or more executable instructions for implementing a specified logic function. In some alternative implementations, functions annotated in the blocks may alternatively be executed in a different order from those annotated in the accompanying drawings. For example, two boxes shown in succession may actually be performed basically in parallel, and sometimes the two boxes may be performed in a reverse order. This depends on the functions involved. Each box of the block diagrams or the flowcharts and combinations of boxes in the block diagrams or the flowcharts may be implemented by a dedicated hardware-based system that performs specified functions or operations, or may be implemented by a combination of dedicated hardware and a computer program.

A related unit described in one or more embodiments of this disclosure may be implemented in a software manner, or may be implemented in a hardware manner, or the described unit may be disposed in processing circuitry (e.g., a processor). Names of these units do not constitute a limitation on the units in a particular case.

In another aspect, this disclosure further provides a non-transitory computer-readable storage medium. The non-transitory computer-readable storage medium may be included in the electronic device described in the foregoing embodiments. or the electronic device may exist alone and is not assembled into the electronic device. The computer-readable medium carries one or more computer programs, and when the one or more computer programs are executed by the electronic device, the electronic device is caused to implement the methods described in the foregoing embodiments.

Although a plurality of modules or units of a device configured to perform actions are mentioned in the foregoing detailed description, such division is not mandatory. In fact, according to the implementations of one or more embodiments of this disclosure, the features and functions of the two or more modules or units described above may be embodied in one module or unit. On the contrary, the features and functions of one module or unit described above may further be divided to be embodied by a plurality of modules or units.

Through the foregoing descriptions of the implementations, a person skilled in the art may understand that the implementations described herein may be implemented by software, or may be implemented by combining software with hardware. Therefore, the technical solutions according to the implementations of this disclosure may be embodied in a form of a software product. The software product may be stored in a non-volatile storage medium (which may be a CD-ROM, a USB flash drive, a removable hard disk, or the like) or on the network, including several instructions for enabling an electronic device to perform the method according to the implementations of this disclosure. For example, the electronic device may be an access network element, and then the access network element may perform the data transmission method shown in FIG. 4 and FIG. 5.

Other implementation solutions of this disclosure may be designed after considering the implementations disclosed in the description and practicing herein. This disclosure is intended to cover any variations, usages, or adaptive changes of this disclosure. These variations, usages, or adaptive changes follow the general principles of this disclosure are within the scope of this disclosure.

This disclosure is not limited to the structures described above and shown in the accompanying drawings, and various modifications and changes may be made without departing from the scope of this disclosure.

What is claimed is:

1. A data transmission method, comprising:
determining whether a plurality of quality of service (QoS) flows meets a synchronous transmission criterion; and
when the plurality of QoS flows is determined to meet the synchronous transmission criterion,
allocating transmission resources to the plurality of QoS flows based on a synchronization requirement,
monitoring whether transmission processes of the plurality of QoS flows meet the synchronization requirement, and
adjusting the transmission resources allocated to the plurality of QoS flows when the transmission processes of the plurality of QoS flows are determined not to meet the synchronization requirement.

2. The data transmission method according to claim 1, wherein the determining whether the plurality of QoS flows meets the synchronous transmission criterion comprises:
receiving from a core network element a designated indication parameter, and determining whether the plurality of QoS flows meets the synchronous transmission criterion based on the designated indication parameter; or
inferring whether the plurality of QoS flows meets the synchronous transmission criterion based on one or more other parameters that are not designated to indicate whether the plurality of QoS flows meets the synchronous transmission criterion.

3. The data transmission method according to claim 2, wherein the designated indication parameter includes a multi-modality service identifier indicating that one or more target QoS flows within a same protocol data unit (PDU) session have an association relationship.

4. The data transmission method according to claim 2, wherein the inferring whether the plurality of QoS flows meets the synchronous transmission criterion comprises:
inferring, according to a session-level QoS parameter included in user equipment context information, whether the plurality of QoS flows meets the synchronous transmission criterion; or
inferring, according to a QoS flow-level QoS parameter included in the user equipment context information, whether the plurality of QoS flows meets the synchronous transmission criterion; or
when a synchronization constraint is configured by the core network element, determining that the plurality of QoS flows included in a same PDU session meets the synchronous transmission criterion.

5. The data transmission method according to claim 1, further comprising:
when the plurality of QoS flows is determined to meet the synchronous transmission criterion, generating a synchronous transmission parameter for the plurality of QoS flows, wherein the synchronous transmission parameter includes at least one of a protocol data unit (PDU) set delay budget (PSDB) or a packet delay budget (PDB) for an access network.

6. The data transmission method according to claim 1, wherein the monitoring whether the transmission processes of the plurality of QoS flows meet the synchronization requirement comprises:
determining that the plurality of QoS flows has a same transmission delay when the plurality of QoS flows is transmitted based on the allocated transmission resources.

7. The data transmission method according to claim 1, wherein the allocating the transmission resources to the plurality of QoS flows based on the synchronization requirement comprises:
allocating a same data radio bearer based on the synchronization requirement; or
allocating different data radio bearers to the plurality of QoS flows based on the synchronization requirement.

8. The data transmission method according to claim 1, wherein the monitoring whether the transmission processes of the plurality of QoS flows meet the synchronization requirement comprises:
performing delay detection on the transmission processes of the plurality of QoS flows.

9. The data transmission method according to claim 8, wherein the performing the delay detection comprises:
for a QoS flow transmitted based on an unacknowledged mode, performing the delay detection through a radio link control (RLC) instance of a receive end on uplink transmission, or performing the delay detection through an RLC instance of a transmit end on downlink transmission; and
for a QoS flow transmitted based on an acknowledged mode, performing delay detection through an RLC instance shared by the uplink transmission and the downlink transmission.

10. The data transmission method according to claim 8, wherein the performing the delay detection comprises:
performing a first delay measurement on the plurality of QoS flows by using a data packet as a unit; or
performing a second delay measurement on the plurality of QoS flows by using a transport block as a unit.

11. The data transmission method according to claim 8, further comprising:
when a transmission delay difference among data packets of the plurality of QoS flows is within a reference range, determining that the transmission processes of the plurality of QoS flows meet the synchronization requirement; and
when the transmission delay difference among the data packets of the plurality of QoS flows is not within the reference range, determining that the transmission processes of the plurality of QoS flows do not meet the synchronization requirement.

12. The data transmission method according to claim 8, further comprising:
indicating, based on a delay detection result of the plurality of QoS flows by using different states of a state machine, whether the transmission processes of the plurality of QoS flows meet the synchronization requirement, wherein the state machine includes a synchronized state and an unsynchronized state.

13. The data transmission method according to claim 8, further comprising:
when the transmission processes of the plurality of QoS flows are determined to not meet the synchronization requirement for a set duration after the transmission resources allocated to the plurality of QoS flows are adjusted, transmitting a notification message to a core network element, the core network element being configured to adjust a transmission parameter for the plurality of QoS flows based on the notification message.

14. A data transmission apparatus, comprising:
processing circuitry configured to:
determine whether a plurality of quality of service (QoS) flows meets a synchronous transmission criterion; and
when the plurality of QoS flows is determined to meet the synchronous transmission criterion,
allocate transmission resources to the plurality of QoS flows based on a synchronization requirement,
monitor whether transmission processes of the plurality of QoS flows meet the synchronization requirement, and
adjust the transmission resources allocated to the plurality of QoS flows when the transmission processes of the plurality of QoS flows are determined not to meet the synchronization requirement.

15. The data transmission apparatus according to claim 14, wherein the processing circuitry is configured to:
receive from a core network element a designated indication parameter, and determine whether the plurality of QoS flows meets the synchronous transmission criterion based on the designated indication parameter; or
infer whether the plurality of QoS flows meets the synchronous transmission criterion based on one or more other parameters that are not designated to indicate whether the plurality of QoS flows meets the synchronous transmission criterion.

16. The data transmission apparatus according to claim 14, wherein the processing circuitry is configured to:
when the plurality of QoS flows is determined to meet the synchronous transmission criterion, generate a synchronous transmission parameter for the plurality of QoS flows, wherein the synchronous transmission parameter includes at least one of a protocol data unit (PDU) set delay budget (PSDB) or a packet delay budget (PDB) for an access network.

17. The data transmission apparatus according to claim 14, wherein the processing circuitry is configured to:
perform delay detection on the transmission processes of the plurality of QoS flows.

18. The data transmission apparatus according to claim 17, wherein the processing circuitry is configured to:
for a QoS flow transmitted based on an unacknowledged mode, perform the delay detection through a radio link control (RLC) instance of a receive end on uplink transmission, or perform the delay detection through an RLC instance of a transmit end on downlink transmission; and
for a QoS flow transmitted based on an acknowledged mode, perform delay detection through an RLC instance shared by the uplink transmission and the downlink transmission.

19. The data transmission apparatus according to claim 17, wherein the processing circuitry is configured to:
when a transmission delay difference among data packets of the plurality of QoS flows is within a reference range, determine that the transmission processes of the plurality of QoS flows meet the synchronization requirement; and
when the transmission delay difference among the data packets of the plurality of QoS flows is not within the reference range, determine that the transmission processes of the plurality of QoS flows do not meet the synchronization requirement.

20. A non-transitory computer-readable storage medium storing instructions, which when executed by a processor, cause the processor to perform a data transmission method, the method comprising:
determining whether a plurality of quality of service (QoS) flows meets a synchronous transmission criterion; and
when the plurality of QoS flows is determined to meet the synchronous transmission criterion,
allocating transmission resources to the plurality of QoS flows based on a synchronization requirement,
monitoring whether transmission processes of the plurality of QoS flows meet the synchronization requirement, and
adjusting the transmission resources allocated to the plurality of QoS flows when the transmission processes of the plurality of QoS flows are determined not to meet the synchronization requirement.
